(19) United States
(12) Patent Application Publication
(10) Pub. No.: US 2025/0325914 A1
(43) Pub. Date: Oct. 23, 2025

(54) MANIPULABLE SILICONE TOY ATTACHMENT FOR BABY BOTTLE

(71) Applicant: Jennifer Brooke Albano, Austin, TX (US)

(72) Inventor: Jennifer Brooke Albano, Austin, TX (US)

(21) Appl. No.: 19/002,971

(22) Filed: Dec. 27, 2024

Related U.S. Application Data
(60) Provisional application No. 63/637,635, filed on Apr. 23, 2024.

(51) Int. Cl. A63H 3/14; A61J 9/06

(52) U.S. Cl. CPC A63H 3/14; A61J 9/0607

(57) ABSTRACT

A baby bottle attachment may enhance the feeding experience of infants. The attachment may comprise a one-piece silicone toy that fits over the bottom portion of a standard baby bottle, featuring an interactive head portion that extends outward from the bottle. The interactive head portion may be hollow and include a cavity sized and shaped to accommodate the tip of a caregiver's finger, allowing the caregiver to animate the toy during feeding. The attachment may be made of soft, flexible silicone material, making it safe for use with infants and easy to clean. It may be lightweight, portable, and visually stimulating for infants. This attachment may provide a simple yet effective solution for reducing distractions during infant feeding, improving the feeding experience for both infants and caregivers.

### FIELD OF THE DISCLOSURE

The present disclosure generally relates to bottles with nipples for dispensing fluids, such as are used for the care and feeding of infants and young children, and more particularly, to manipulable toy attachments for bottles.

### BACKGROUND

Feeding infants is a critical caregiving task essential for their growth and development. However, caregivers frequently encounter challenges during bottle feeding sessions, as infants easily become distracted and disinterested, resulting in incomplete feeds and potential nutritional gaps.

Current approaches to address distracted feedings in infants are limited. Caregivers are often advised to feed distracted infants in quiet, dimly lit environments, which may be effective on occasion but is not practical for most feeding situations. Another common suggestion is to use a favorite toy to capture the infant's attention during feeding. While this method can be successful, it requires the presence of a second person to manage the toy, which is not always feasible when a caregiver is feeding the infant alone. Some caregivers resort to showing videos on a smartphone to keep the infant focused; however, this contradicts medical recommendations that infants avoid screen time.

Conventional baby bottles lack visual stimuli to captivate infants during feeding. Although some bottles include decorative elements, these designs are often limited in their effectiveness. Decorations positioned on the sides of the bottle are not visible to the infant when the bottle is in use. Additionally, all of these existing options do not provide caregivers with ease or convenience during what is already a stressful time. Parents and caregivers of newborns and bottle-fed infants already contend with numerous challenges and stressors in their daily routines. Managing distracted feedings without a dedicated solution adds unnecessary burdens, which this invention aims to alleviate.

### SUMMARY

Embodiments of the present disclosure may provide a simple, affordable, and purpose-built product that can help caregivers manage distracted feedings during infant feedings. More particularly, a one-piece silicone toy attachment may fit over a standard baby bottle, captivating infants with its interactive head and keeping them focused on feeding. By offering a practical and accessible solution, embodiments of the present disclosure may improve the feeding experience for both infants and caregivers, promoting healthier feeding habits and overall well-being. Accordingly, the infant's interest may be maintained while diverting the infant's attention from the feeding process, allowing the infant to consume the contents of the bottle without interruption.

Embodiments of the present disclosure may provide a manipulable baby bottle toy attachment comprising: a body portion capable of fitting over a bottom portion of the baby bottle; and a hollow interactive head portion connected to the body portion and capable of extending outward from the baby bottle, the interactive head portion having a cavity sized and shaped to accommodate at least a tip of a user's index finger. The toy attachment also may comprise a ring-like member capable of attaching the toy attachment to the baby bottle. The ring-like member may have a circular opening located proximate to a center of the interactive head portion to receive the baby bottle. The ring-like member may be flexible and capable of stretching to engage the baby bottle for gripping and re-forming to hold on to the baby bottle while the interactive head portion orients to a top of the baby bottle. The toy attachment may be formed in one piece. The toy attachment may be formed of a flexible, non-toxic material, which may be silicone. The interactive head portion may have a design that is visually stimulating for an infant engaging with the baby bottle. The toy attachment may be lightweight and/or portable. The toy attachment may be left on the baby bottle when feeding is complete and/or it may be removed and given to an infant to play with when feeding is complete.

Other embodiments of the present disclosure may provide a method for enhancing an infant feeding experience comprising attaching a manipulable baby bottle toy attachment to a baby bottle, the manipulable baby bottle toy attachment having a cavity to receive a user's finger and an interactive head portion; and using the user's finger, animating the interactive head portion during the infant feeding experience. The manipulable baby bottle toy attachment may have a body portion capable of fitting over a bottom portion of the baby bottle. The toy attachment also may include a ring-like member capable of attaching the toy attachment to the baby bottle. The ring-like member may be flexible and capable of stretching to engage the baby bottle for gripping and re-forming to hold on to the baby bottle while the interactive head portion orients to a top of the baby bottle. The toy attachment may be formed in one piece. It may be formed of a flexible, non-toxic material. The interactive head portion may have a design that is visually stimulating for an infant engaging with the baby bottle. The method also may include removing the toy attachment and giving to an infant to play with when feeding is complete.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 depicts a front view of a toy attachment according to an embodiment of the present disclosure;

FIG. 2 illustrates a side view of a toy attachment attached to a baby bottle according to an embodiment of the present disclosure; and

FIG. 3 depicts a rear view of a toy attachment with a user's finger inserted according to an embodiment of the present disclosure.

### DETAILED DESCRIPTION

Embodiments of the present disclosure may provide a one-piece silicone toy attachment designed to enhance the feeding experience of infants. The interactive head portion of the toy attachment may be hollow and include a cavity that may be sized and shaped to accommodate the tip of a user's index finger. This configuration may allow the user to insert their finger into the head of the toy and animate it by wiggling their finger, creating movement and engagement that can help keep the infant focused during feeding.

The attachment may be configured to fit over a bottom portion of a standard baby bottle which is a generally cylindrical bottle having a closed end and an open end including a nipple. The attachment also may include an interactive head portion that extends outward from the bottle. The attachment may be made of flexible, non-toxic silicone material, making it safe for use with infants and easy to clean. While the attachment is described to fit over a standard baby bottle, it should be appreciated that the attachment may be used with other types of bottles without departing from the present disclosure. Further, while the attachment is described as made of silicone material, it should be appreciated that other flexible, non-toxic materials may be used to form the attachment without departing from the present disclosure.

A ring-like member may attach the toy attachment to the bottle, and the ring-like member may contain a generally circular opening located proximate to the center of the toy which may be sized for receiving the bottle. The opening may contain a flexible ring-like member having an inner diameter that may be at least slightly smaller than the outer diameter of the bottle. Bottles may range in size from approximately 1.5 inches to 3 inches in width, and the ring-like member may be sized to fit snuggly on the outside base of the narrowest bottles and stretch wide enough without breaking to easily adapt to the widest bottomed bottles as well. Insertion of the bottle into the opening may result in the ring-like member stretching to engage the bottle for gripping and re-forming to hold on to the bottle while the toy orients to the top of the bottle, allowing for manual animation of the toy while feeding. While the member is described as ring-like, it may assume other configurations relative to the diameter and shape of the portion of the bottle to which it may engage in embodiments of the present disclosure.

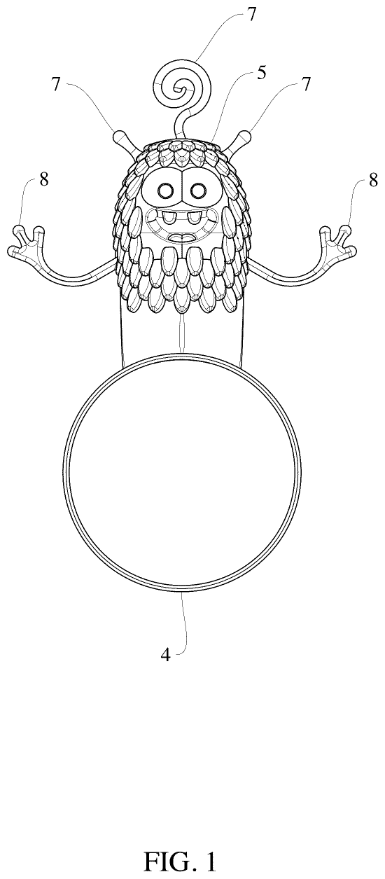

FIG. 1 depicts a front view of a toy attachment according to an embodiment of the present disclosure. As depicted herein, the attachment may include ring-like member 4, which may be formed of silicone material in an embodiment of the present disclosure. After a caregiver has filled the baby bottle with liquid and sealed the open end with a nipple and nipple cap, the caregiver may stretch ring-like member 4 to securely fit over the bottom of the baby bottle. This may orient toy head 5 toward the nipple of the baby bottle, which may, in turn, face the infant during feeding. The infant may then be fed in the usual manner. However, when the infant is being fed with a bottle having the toy attachment, the caregiver may insert their index finger into the hollow portion of the toy attachment. Once inserted, the index finger may animate the toy of the toy attachment while feeding, subsequently making head appendages 7 and body appendages 8 move and wiggle.

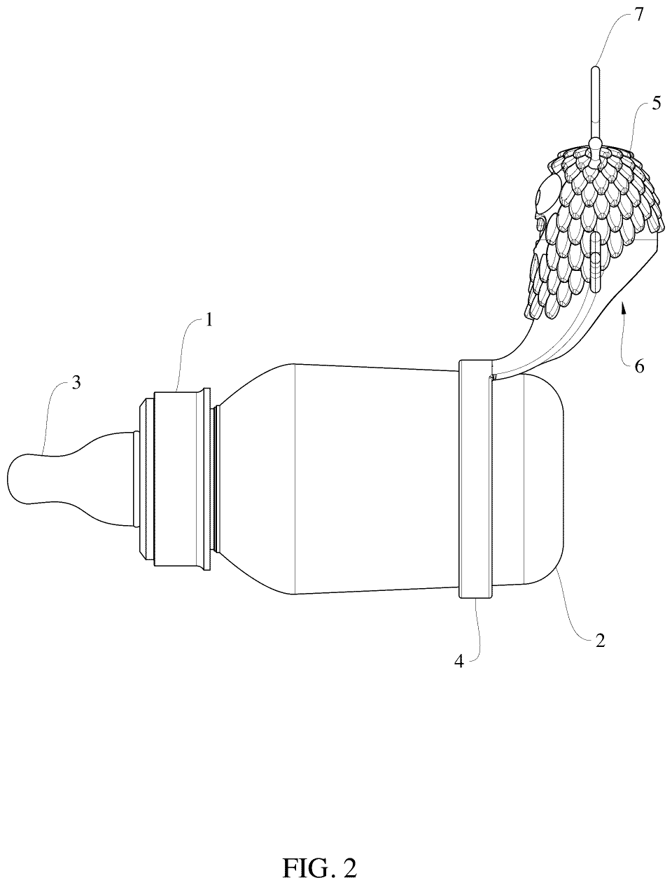

FIG. 2 illustrates a side view of a toy attachment attached to a baby bottle according to an embodiment of the present disclosure. The toy attachment may be used with any conventional infant nursing bottle having open end 1 and closed end 2. Open end 1 may house nipple 3 in an embodiment of the present disclosure. As depicted herein, the infant bottle may have a generally cylindrical construction with a neck portion within which the base of nipple 3 may be maintained in position. However, it should be appreciated that bottles of any shape or size may be used with the toy attachment according to embodiments of the present disclosure. Ring-like member 4 is depicted as securely fitting over a bottom portion of the baby bottle. As depicted herein, toy head 5 may be oriented toward nipple 3 of the baby bottle. The caregiver may insert their index finger into the hollow portion of the toy attachment, which may be illustrated as finger cavity 6. Once inserted, the index finger may animate the toy while feeding, subsequently making head appendages 7 and body appendages 8 move and wiggle. This animation action may be unique to this toy and may entertain and amuse the infant while feeding, allowing them to focus on the bottle, take in more nutritional feeds, and reduce other distractions. Moreover, the infant can grasp or otherwise engage with the arms and body of the toy attachment during feeding, resulting in further amusement and connection.

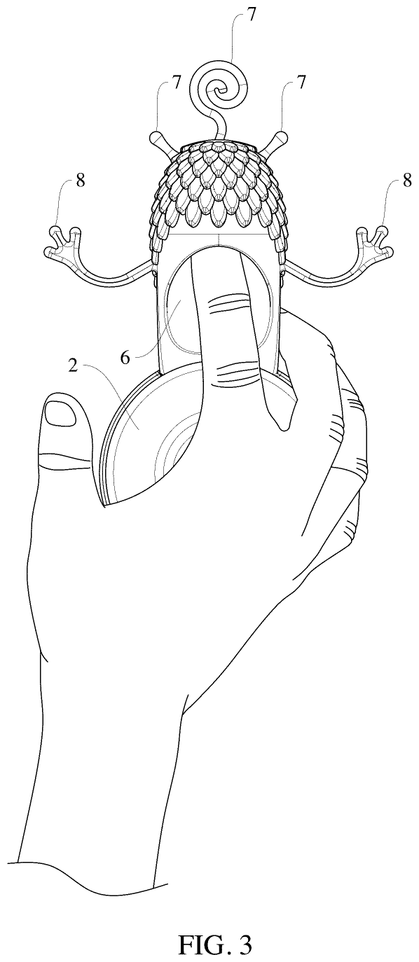

FIG. 3 depicts a rear view of a toy attachment with a user's finger inserted according to an embodiment of the present disclosure. Closed end 2 is depicted in FIG. 3 as being in the palm of the caregiver's hand. The caregiver's index finger may be inserted into finger cavity 6. Once inserted into finger cavity 6, the index finger may animate the toy while feeding, subsequently making head appendages 7 and body appendages 8 move and wiggle. When feeding is complete, the manipulable silicone toy attachment can either be left on the bottle and later removed when the bottle is washed. Alternatively, the attachment can be removed and given to the child to play with as it can double as a stand-alone interactive toy.

The attachment according to embodiments of the present disclosure may be lightweight and portable, making it convenient for users to use at home or on the go. In an embodiment of the present disclosure, the attachment may range be under 1 oz or under 25 grams, and more particularly, may be 0.7 ounces (or 20 grams). It also may be durable and resistant to damage, ensuring that it can withstand regular use and cleaning. Overall, the attachment according to embodiments of the present disclosure may provide a simple yet effective solution for reducing distractions during infant feeding, improving the feeding experience for both infants and caregivers.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A manipulable baby bottle toy attachment comprising:
a body portion capable of fitting over a bottom portion of the baby bottle; and
a hollow interactive head portion connected to the body portion and capable of extending outward from the baby bottle, the interactive head portion having a cavity sized and shaped to accommodate at least a tip of a user's index finger.

2. The manipulable baby bottle toy attachment of claim 1 further comprising:
a ring-like member capable of attaching the toy attachment to the baby bottle.

3. The manipulable baby bottle toy attachment of claim 2, wherein the ring-like member has a circular opening located proximate to a center of the interactive head portion to receive the baby bottle.

4. The manipulable baby bottle toy attachment of claim 2, wherein the ring-like member is flexible and capable of stretching to engage the baby bottle for gripping and re-forming to hold on to the baby bottle while the interactive head portion orients to a top of the baby bottle.

5. The manipulable baby bottle toy attachment of claim 1, wherein the toy attachment is formed in one piece.

6. The manipulable baby bottle toy attachment of claim 1, wherein the toy attachment is formed of a flexible, non-toxic material.

7. The manipulable baby bottle toy attachment of claim 6, wherein the flexible, non-toxic material is silicone.

8. The manipulable baby bottle toy attachment of claim 1, wherein the interactive head portion has a design that is visually stimulating for an infant engaging with the baby bottle.

9. The manipulable baby bottle toy attachment of claim 1, wherein the toy attachment is lightweight.

10. The manipulable baby bottle toy attachment of claim 1, wherein the toy attachment is portable.

11. The manipulable baby bottle toy attachment of claim 1, wherein the toy attachment is left on the baby bottle when feeding is complete.

12. The manipulable baby bottle toy attachment of claim 1, wherein the toy attachment is removed and given to an infant to play with when feeding is complete.

13. A method for enhancing an infant feeding experience comprising:
attaching a manipulable baby bottle toy attachment to a baby bottle, the manipulable baby bottle toy attachment having a cavity to receive a user's finger and an interactive head portion; and
using the user's finger, animating the interactive head portion during the infant feeding experience.

14. The method of claim 13, wherein the manipulable baby bottle toy attachment has a body portion capable of fitting over a bottom portion of the baby bottle.

15. The method of claim 13, the manipulable baby bottle toy attachment further comprising:
a ring-like member capable of attaching the toy attachment to the baby bottle.

16. The method of claim 15, wherein the ring-like member is flexible and capable of stretching to engage the baby bottle for gripping and re-forming to hold on to the baby bottle while the interactive head portion orients to a top of the baby bottle.

17. The method of claim 13, wherein the toy attachment is formed in one piece.

18. The method of claim 13, wherein the toy attachment is formed of a flexible, non-toxic material.

19. The method of claim 13, wherein the interactive head portion has a design that is visually stimulating for an infant engaging with the baby bottle. 20 The method of claim 13 further comprising:
removing the toy attachment and giving to an infant to play with when feeding is complete.
